(19) United States
(12) Patent Application Publication
(10) Pub. No.: US 2009/0018789 A1
(43) Pub. Date: Jan. 15, 2009

(54) IMAGE AUTO-CALIBRATION METHOD AND SYSTEM

(75) Inventors: Jen-Chung Weng, Hsinchu (TW); Chien-Hsien Tsai, Hsinchu (TW)

Correspondence Address: VOLPE AND KOENIG, P.C., UNITED PLAZA, SUITE 1600, 30 SOUTH 17TH STREET, PHILADELPHIA, PA, 19103, US

(73) Assignee: HOLTEK SEMICONDUCTOR INC., Hsinchu (TW)

(21) Appl. No.: 12/036,830

(22) Filed: Feb. 25, 2008

(30) Foreign Application Priority Data
Jul. 13, 2007 (TW) 096125756

(51) Int. Cl. G03B 43/00

(52) U.S. Cl. 702/85

(57) ABSTRACT

An image auto-calibration method for an image capture device having an image sensor is provided. The method includes the steps of receiving an image matrix; transforming the image matrix into an image signal via the image sensor; generating n first sampling pulses and n second sampling pulses in response to the image signal, wherein one of the first sampling pulses and one of the second sampling pulses constitute a sampling pulse set; calculating an eigenvalue of the image signal according to each of the sampling pulse sets; and outputting an image according to the sampling pulse set with the largest eigenvalue.

### FIELD OF THE INVENTION

The present invention relates to an image auto-calibration method and system, and more particularly to an image auto-calibration method and system for an image capture device.

### BACKGROUND OF THE INVENTION

The growth in the consumer market of the multimedia is tremendous in recent years and the charge-coupled device (CCD) is widely used in the multimedia for serving as their image sensor. During the process of an image capture in a CCD system, the image transmitted to the CCD is converted into electrical signals and output from the CCD. After sampled, the electrical signals will be processed in an image processor. At last, the processed signals are output from the image processor and displayed on a display monitor according to the sampling. In brief, the CCD system converts a light energy into an electrical energy by the way of “sampling”, and thus finding an optimal timing for the best sampling point of the output signals of the CCD is the most fundamental element affecting the image quality. In the prior arts, in order to maintain the same brightness and color between the display monitors of the same type, the sample-and-hold pulses of the display monitors of the same type are set identical (the sampling pulse, SHP, refers to the reset hold level of sampling signals and the sampling pulse, SHD, refers to the actual video level of sampling signals, and the difference between the two sampling pulses is the output of a pixel). However, because the processes of integrated circuits and print circuits are hard to maintain stable and identical, the adjustment in the sample-and hold pulses (SHP, SHD) for accurately matching the timing of the output of the image signals is usually required.

In the past, the display monitors of the same type are manually adjusted one by one for achieving optimal and identical image quality before they leave a factory. This adjusting method not only wastes time and cost, but also lacks an identical reference standard for the image adjustment.

For example, the US Publication Nos. 20040008388 and 20030235260 both solve the defects in the prior arts by the way of circuit designs. However, this method not only has high cost, but also cannot find an optimal timing for the best sampling point automatically.

Hence, because of the defects in the prior arts, the inventors provide an image auto-calibration method and system, which find an optimal timing for the best sampling point of an image signal automatically by a statistic method. The present invention effectively overcomes the above defects in the prior arts, simplifies the process of the image adjustment and provides a standard for the adjustment, through which a better image display is obtained.

### SUMMARY OF THE INVENTION

It is an aspect of the present invention to provide an image auto-calibration method and system for solving problems of high cost and time waste of the image adjustments for image capture devices.

In accordance with an aspect of the present invention, an image auto-calibration method for an image capture device having an image sensor is provided. The image auto-calibration method comprises the steps of receiving an image matrix; transforming the image matrix into an image signal via the image sensor; generating n first sampling pulses and n second sampling pulses in response to the image signal, wherein one of the first sampling pulses and one of the second sampling pulses constitute a sampling pulse set; calculating an eigenvalue of the image signal according to each of the sampling pulse sets; and outputting an image according to the sampling pulse set with the largest eigenvalue.

Preferably, the image auto-calibration method further comprises a step of separating the image matrix into a plurality of blocks.

Preferably, the step of calculating the eigenvalue further comprises circularly calculating a sum of RGB pixel values of each block and summing the sum of the RGB pixel values of the each block to obtain the eigenvalue.

Preferably, the image auto-calibration method further comprises a step of generating a sampling clock by a timing generator so as to generate the n first sampling pulses and the n second sampling pulses in response to the image signal.

Preferably, the image auto-calibration method further comprises a step of eliminating a part of the sampling pulse sets in advance so as to reduce a calculating time for the eigenvalues.

Preferably, the image auto-calibration method further comprises a step of comparing the eigenvalues calculated according to the sampling pulse sets with each other.

Preferably, the image matrix comprises a plurality of image pixels.

Preferably, the image sensor is a charge-coupled device, and the image matrix is generated from an image.

Preferably, the eigenvalue is a sum of RGB pixel values of the image signal.

In accordance with another aspect of the present invention, an image auto-calibration system for an image capture device having an image display module for displaying an image is provided. The image auto-calibration system comprises a statistic module coupled to the image capture device for calculating eigenvalues of the image according to a plurality of sampling pulse sets; and a calibrating module coupled to the statistic module for comparing the eigenvalues with each other and using a largest eigenvalue as a reference for displaying the image.

Preferably, the image capture device further comprises an image capture module for capturing an image matrix, and an image processing module.

Preferably, the image capture module comprises an image sensor for converting the image matrix into an image signal.

Preferably, the image matrix comprises a plurality of image pixels.

Preferably, the image sensor is a charge-coupled device.

Preferably, each of the plurality of sampling pulse sets comprises a first sampling pulse and a second sampling pulse, and each eigenvalue is corresponding to each of the plurality of the sampling pulse sets.

Preferably, both the first sampling pulse and the second sampling pulse are generated in response to the image signal.

Preferably, the eigenvalue is a sum of RGB pixel values of the image matrix.

Preferably, the image auto-calibration system further comprises a sampling device for generating the plurality of sampling pulse sets for the image.

In accordance with a further aspect of the present invention, an image auto-calibration method for an image capture device is provided. The image auto-calibration method for the image capture device comprises the steps of generating a plurality of sampling pulse sets for an image captured by the image capture device; calculating eigenvalues for the sampling pulse sets; and outputting an image based on a largest one of the eigenvalues.

Preferably, the image auto-calibration method further comprises a step of summing RGB pixel values for the image according to the sampling pulse sets.

The above objects and advantages of the present invention will become more readily apparent to those ordinarily skilled in the art after reviewing the following detailed descriptions and accompanying drawings, in which:

### BRIEF DESCRIPTION OF THE DRAWINGS

FIG. 1 is a diagram showing the image capture device in the present invention;

FIG. 2 is a diagram showing various clock signals in the present invention;

FIG. 3 is a flow chart showing the process of the image auto-calibration in the present invention;

FIG. 4 is a flow chart showing the statistic process of eigenvalues in the present invention; and

FIG. 5 is a diagram showing that the captured image is separated evenly into 35 blocks in the present invention.

### DETAILED DESCRIPTION OF THE PREFERRED EMBODIMENT

The present invention will now be described more specifically with reference to the following embodiments. It is to be noted that the following descriptions of preferred embodiments of this invention are presented herein for the purposes of illustration and description only; it is not intended to be exhaustive or to be limited to the precise form disclosed.

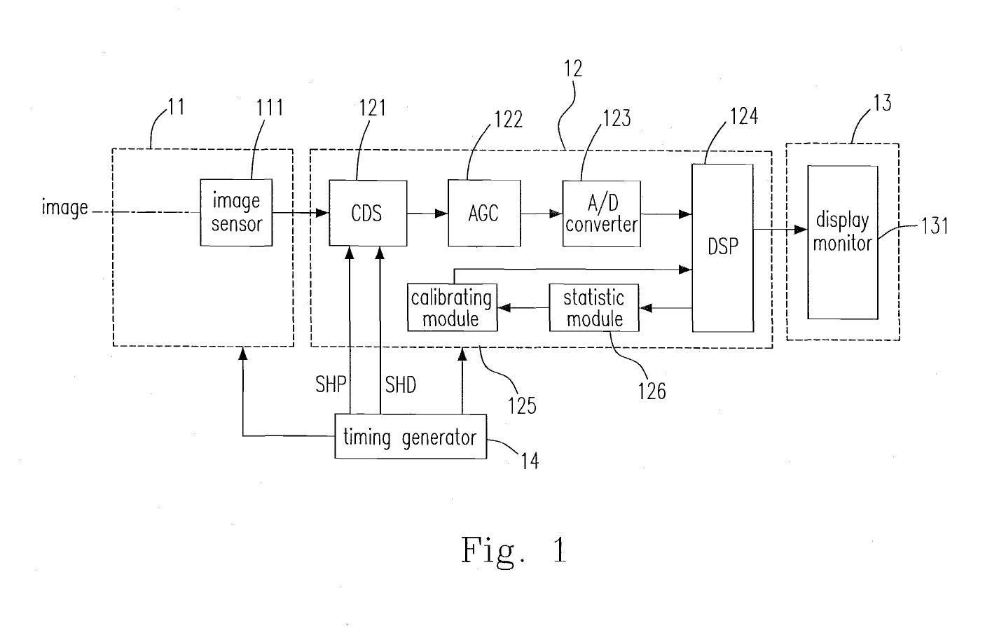

Please refer to FIG. 1, which is a diagram showing the image capture device in the present invention. The image capture device comprises an image capture module 11 for capturing an image, an image processing module 12 and an image display module 13 for displaying the image according to a sampling pulse set. The image auto-calibration system of the present invention is configured in the image capture device and comprises a statistic module 126 and a calibrating module 125. The image capture module 11 comprises an image sensor 111 for sensing a focussed image and converting it into an image signal, wherein the image input to the image sensor 111 is an image matrix and the output signal thereof is an analog signal. The image sensor 111 according to this embodiment is a charge-coupled device (CCD); however, the image sensor 111 of the present invention could be any device capturing image signals via differential signals.

The image signal output from the image sensor 111 needs to be processed in the image processing module 12 for carrying out the image process. The image processing module 12 comprises a correlated double sampler (CDS) 121 carrying out correlated double sampling for removing noise from the CCD readout signal, an automatic gain control (AGC) 122 automatically adjusting a gain of an output signal of the CDS 121, an analog-to-digital (A/D) converter 123 converting an analog signal from the AGC into a digital signal, and a digital signal processor (DSP) 124 processing the digital data output from the A/D converter to generate image signals including a brightness signal and a color difference signal. The processed image signal from the DSP is displayed on a display monitor 131 configured in the image display module 13.

Please refer to FIG. 1 again. A plurality of clock signals, including two sampling pulses (SHP and SHD), are provided to respective circuit elements, such as the image sensor 111 and the CDS 121, by a timing generator 14. According to this embodiment, the SHP refers to a first sampling pulse and the SHD refers to a second sampling pulse. The two sampling pulses are derived from a sampling clock generated by the timing generator 14. In order to reduce the noise from the output signal of the image sensor 111, the CDS 121 is required to sample the output signal of the image sensor 111 at two given points represented by the SHP and the SHD and give an output proportional to the difference in the voltage levels between these two points of each pixel.

Please refer to FIG. 1 again. The processed image signal from the DSP is sent to a statistic module 126, and then the statistic module calculates an eigenvalue of the image according to a sampling pulse set and outputs the eigenvalue to a calibrating module 125. The calibrating module 125 compares eigenvalues sent from the statistic module 126 with each other and keeps the sampling pulse set with the largest eigenvalue. The sampling pulse set with the largest eigenvalue will be sent to the DSP 124 for serving as a reference for outputting the image.

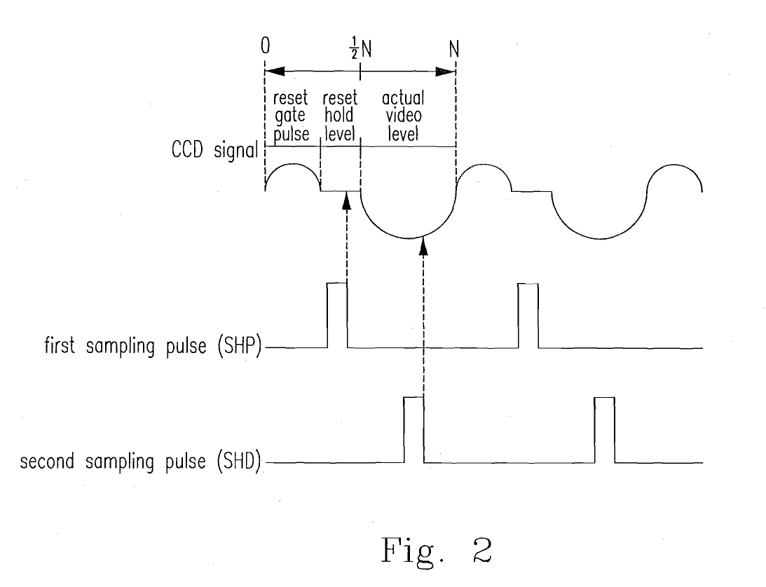

Please refer to FIG. 2, which is a diagram showing various clock signals in the present invention. The image signal output from the image sensor 111 can be separated into three main parts, a reset gate pulse, a reset hold level (a floating gate or a black level) and an actual video level. According to the characteristics of the image sensor 111, the SHP is active during the reset hold level of the output signal of the image sensor 111 and the SHD is active during the actual video level. Accordingly, if a sampling time corresponding to the output signal of the image sensor 111 is divided into N sections, the sampling time point of the SHP will be approximately active before ½N and that of the SHD will be approximately active behind ½N. The divided number N of the sampling time can be adjusted according to the actual necessity. Any one of the SHP and any one of the SHD constitute a sampling pulse set, and the difference between the SHP and the SHD is an actual value of any given pixel. Therefore, the sampling pulse set of each pixel will directly affect the output quality of an image.

For example, when N=10, the SHP might be in a range of sections 0-4 and the SHD might be in a range of sections 5-9. Consequently, any one section for the SHP and any one section for the SHD will generate 25 sampling pulse sets. If the possible active ranges of the SHP and the SHD are disregarded, the number of the sampling pulse sets will be 100 in the case of N=10. In brief, the image auto-calibration system configured in the image processing module 12 finds the optimal timing for the best sampling point of the output signal of the image sensor 111 by calculating eigenvalues of the image according to each possible sampling pulse set.

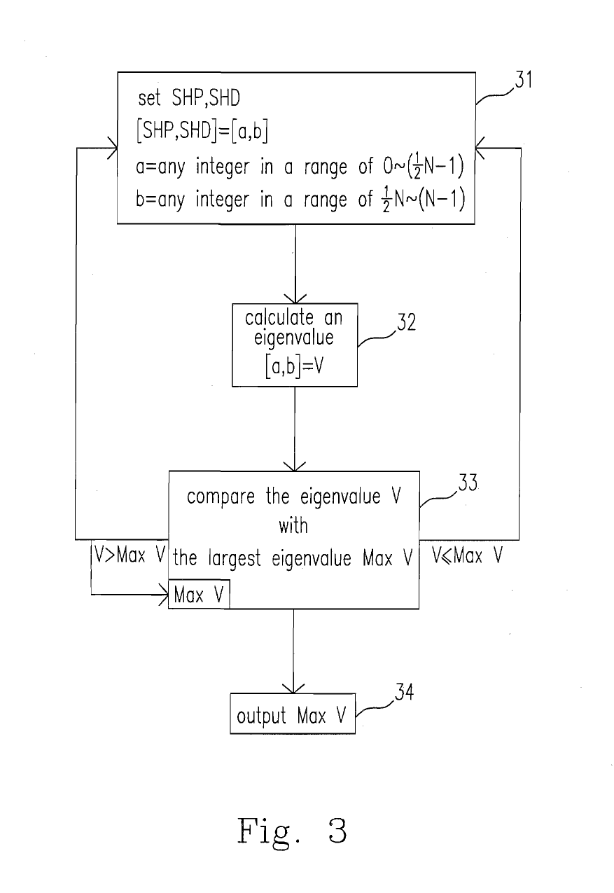

Please refer to FIG. 3, which is a flow chart showing the process of the image auto-calibration in the present invention. The process is executed in the calibrating module 125 of the present invention. In this embodiment, the possible active ranges of the SHP and the SHD are considered in advance in the process of the calibration so as to increase the calculating rate of the system. If a sampling time corresponding to the output signal of the image sensor 111 is divided into N sections, then the SHP corresponding to a value “a” is set in a range of sections 0 to ½N-1 and the SHD corresponding to a value “b” is set in a range of sections ½N to N-1, wherein the two values a and b are integers and accordingly the number N is preferably set as an even number (step 31). An eigenvalue V derived from a sampling pulse set composed of any one section of the SHP and any one section of the SHD is calculated (step 32), wherein the ranges of the SHP and the SHD are predetermined. If there is not any largest eigenvalue Max V recorded in the step 33, the eigenvalue V derived from the process 32 and its corresponding values a and b will be recorded in the step 33. Alternatively, if a record related to the largest eigenvalue Max V already exists in the step 33, the eigenvalue V derived from the process 32 will be compared with the Max V. After comparison, if V≦Max V, the process goes back to the step 31 for choosing another sampling pulse set from the predetermined ranges and calculating the eigenvalue thereof (step 32). If V>Max V, the eigenvalue V substituting for the original Max V will be recorded in the step 33 and the process will go back to the step 31 for choosing another sampling pulse set from the predetermined ranges. The steps 31 to 33 are repeated according to the above mode until all the eigenvalues derived from the sampling pulse sets in the predetermined ranges are calculated and compared with each other. At last, the largest eigenvalue Max V and its corresponding values a and b recorded in the step 33 are read and output to the DSP (step 34).

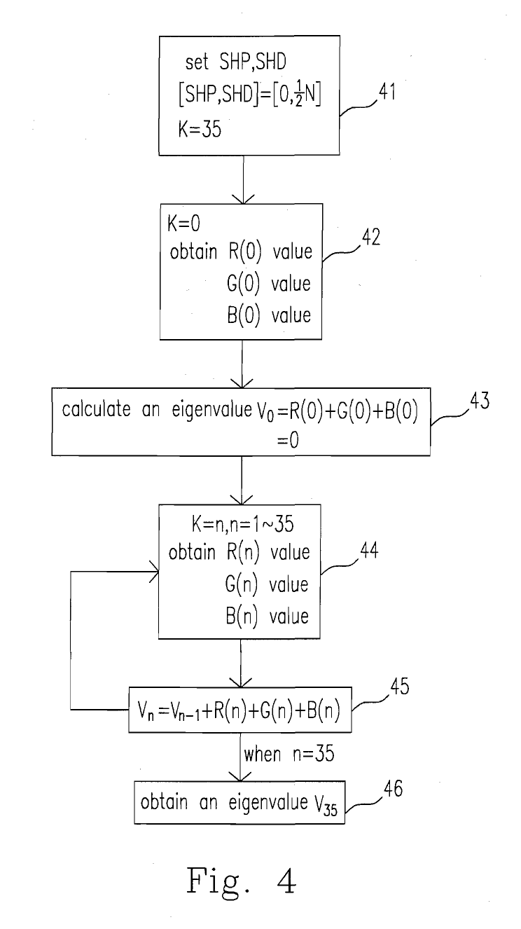

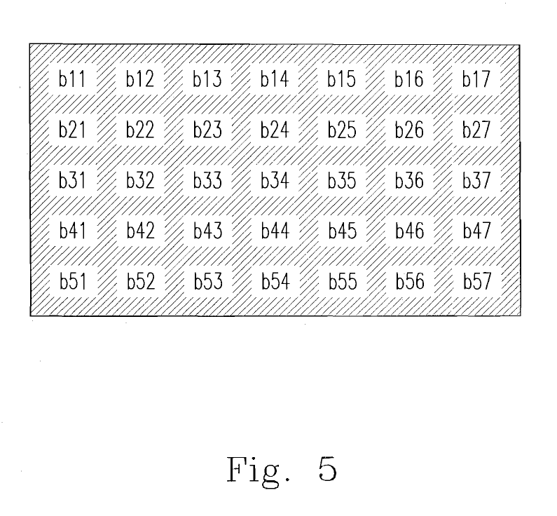

Please refer to FIG. 4 and FIG. 5. FIG. 4 is a flow chart showing the statistic process of eigenvalues in the present invention, i.e. a detailed statistic process of the step 32 of the image auto-calibration shown in FIG. 3. The statistic process of eigenvalues is executed in the statistic module 126 of the present invention. FIG. 5 is a diagram showing that the image captured by the image sensor 111 is separated evenly into 35 blocks for increasing the calculating rate of the system, wherein the block number is represented as K. In the beginning of the statistic process, a sampling pulse set [SHP, SHD] and the block number K are set (step 41), wherein the sampling pulse set [SHP, SHD]=[0, (½)N] and the block number K=35, which serve as an example to calculate the eigenvalue in FIG. 4. In most image-processing applications, colors are represented by specifying separate intensity values for red, green and blue components (R, G, and B). In this embodiment, three primary color intensity data values for each single pixel in one block are summed up respectively. When K=0, three sums of an R(0) value, a G(0) value and a B(0) value are calculated and a sum V₀=0 of the three RGB pixel values is generated accordingly (step 43). When K=1, three sums of an R(1) value, a G(1) value and a B(1) value are calculated (step 44) and a sum V₁=V₀+R(1)+G(1)+B(1) of the three RGB pixel values is generated accordingly (step 45). The steps 44 and 45 are executed circularly until all blocks are calculated and in consequence an eigenvalue V₃₅ is generated. The eigenvalue V₃₅ is the sum of the three RGB pixel values in 35 blocks of an image at a sampling timing of the sampling pulse set [SHP, SHD]=[0, (½)N] of the image.

The sampling pulse set [SHP, SHD]=[a, b] with the largest eigenvalue obtained by the image auto-calibration process according to the present invention is regarded as the optimal timing for the best sampling point of the output signals of the image sensor 111, and therefore the two sampling pulses of the sampling pulse set will serve as a reference for image display. In normal condition, the best sampling point will result in generating the largest pixel output value, which is a calibrating standard for the image auto-calibration process of the present invention. In the foregoing embodiment, there are two ways to increase the calculating rate of the present system. One is to divide a sampling time into N sections for setting the ranges of the SHP and the SHD in advance, and the other is to divide an image matrix into K blocks for effectively calculating eigenvalues. For example, when N=10, if the ranges of the SHP and the SHD are not set previously, there will be 100 possible sampling pulse sets to be considered. However, in this embodiment, only 25 possible sampling pulse sets are considered, which reduces the calibration time of the system effectively. Regarding the division of the image matrix, in the past a sum of total RGB pixel values of an image is calculated for serving as an adjustment standard for several characteristics of the image, such as white balance and so on. Since the above values have been already existent, and only some blocks distributed evenly over the image are required in this embodiment, the calculating time of the present system for the calibration is less. The block number and/or location within the image could be set according to the actual necessity. Based on the above, the image auto-calibration method and system of the present invention simplify the process of the image calibration and effectively reduce time and cost during the manufacture of the image capture devices.

The above image auto-calibration method and system are just preferred embodiments. Any other methods achieving the purpose of auto-calibration by finding the largest pixel output values via the statistic process shall be included in the protecting scopes of the present invention. In addition, the respective configurations of the statistic module and the calibrating module are not limited to the disclosure of the above embodiment. The two modules could be configured in the DSP as well. Besides, the two modules could be configured independently or incorporatedly.

While the invention has been described in terms of what is presently considered to be the most practical and preferred embodiments, it is to be understood that the invention needs not be limited to the disclose embodiments. Therefore, it is intended to cover various modifications and similar arrangements included within the spirit and scope of the appended claims, which are to be accorded with the broadest interpretation so as to encompass all such modifications and similar structures.

What is claimed is:

1. An image auto-calibration method for an image capture device having an image sensor, comprising the steps of:
receiving an image matrix;
transforming the image matrix into an image signal via the image sensor;
generating n first sampling pulses and n second sampling pulses in response to the image signal, wherein one of the first sampling pulses and one of the second sampling pulses constitute a sampling pulse set;
calculating an eigenvalue of the image signal according to each of the sampling pulse sets; and
outputting an image according to the sampling pulse set with the largest eigenvalue.

2. A method as claimed in claim 1, further comprising:
separating the image matrix into a plurality of blocks.

3. A method as claimed in claim 2, wherein the step of calculating the eigenvalue further comprises circularly calculating a sum of RGB pixel values of each block and summing the sum of the RGB pixel values of the each block to obtain the eigenvalue.

4. A method as claimed in claim 1, further comprising:
generating a sampling clock by a timing generator so as to generate the n first sampling pulses and the n second sampling pulses in response to the image signal.

5. A method as claimed in claim 1, further comprising:
eliminating a part of the sampling pulse sets in advance so as to reduce a calculating time for the eigenvalues.

6. A method as claimed in claim 1, further comprising:
comparing the eigenvalues calculated according to the sampling pulse sets with each other.

7. A method as claimed in claim 1, wherein the image matrix comprises a plurality of image pixels.

8. A method as claimed in claim 1, wherein the image sensor is a charge-coupled device, and the image matrix is generated from an image.

9. A method as claimed in claim 1, wherein the eigenvalue is a sum of RGB pixel values of the image signal.

10. An image auto-calibration system for an image capture device having an image display module for displaying an image, comprising:
a statistic module coupled to the image capture device for calculating eigenvalues of the image according to a plurality of sampling pulse sets; and
a calibrating module coupled to the statistic module for comparing the eigenvalues with each other and using a largest eigenvalue as a reference for displaying the image.

11. An image auto-calibration system as claimed in claim 10, wherein the image capture device further comprises an image capture module for capturing an image matrix, and an image processing module.

12. An image auto-calibration system as claimed in claim 11, wherein the image capture module comprises an image sensor for converting the image matrix into an image signal.

13. An image auto-calibration system as claimed in claim 11, wherein the image matrix comprises a plurality of image pixels.

14. An image auto-calibration system as claimed in claim 12, wherein the image sensor is a charge-coupled device.

15. An image auto-calibration system as claimed in claim 11, wherein each of the plurality of sampling pulse sets comprises a first sampling pulse and a second sampling pulse, and each eigenvalue is corresponding to each of the plurality of the sampling pulse sets.

16. An image auto-calibration system as claimed in claim 15, wherein both the first sampling pulse and the second sampling pulse are generated in response to the image signal.

17. An image auto-calibration system as claimed in claim 11, wherein the eigenvalue is a sum of RGB pixel values of the image matrix.

18. An image auto-calibration system as claimed in claim 11, further comprising a sampling device for generating the plurality of sampling pulse sets for the image.

19. An image auto-calibration method for an image capture device, comprising:
generating a plurality of sampling pulse sets for an image captured by the image capture device;
calculating eigenvalues for the sampling pulse sets; and
outputting an image based on a largest one of the eigenvalues.

20. An image auto-calibration method as claimed in claim 19, further comprising:
summing RGB pixel values for the image according to the sampling pulse sets.
